(19) United States
(12) Patent Application Publication
(10) Pub. No.: US 2019/0071742 A1
(43) Pub. Date: Mar. 7, 2019

(54) STEAM CONDENSATION SYSTEM FOR A GRANULATION INSTALLATION

(71) Applicant: PAUL WURTH S.A., Luxembourg (LU)

(72) Inventor: Daniel MICHELS, WARKEN (LU)

(73) Assignee: PAUL WURTH S.A., Luxembourg (LU)

(21) Appl. No.: 15/773,317

(22) PCT Filed: Nov. 30, 2016
(86) PCT No.: PCT/EP2016/079328

§ 371 Date: May 3, 2018

(30) Foreign Application Priority Data
Dec. 1, 2015 (LU) 92891

(51) Int. Cl. C21B 3/08; C21B 7/10

(52) U.S. Cl. CPC C21B 3/08; F27D 15/0286; C21B 7/10

(57) ABSTRACT

The present invention concerns a granulation installation for granulating molten material produced in a metallurgical plant, the installation includes a water injection device, for injecting granulation water into a flow of molten material and thereby granulating the molten material; a granulation tank for collecting the granulation water and the granulated material; and a steam condensation system including a steam collecting hood located above the granulation tank, for collecting steam generated in the granulation tank, a gas conduit arranged between the steam collecting hood and a water column, and a gas compressor arranged within said gas conduit for compressing the steam before feeding it into the water column.

### TECHNICAL FIELD

The present invention generally relates to a granulation installation for molten material, especially for metallurgical melts such as blast furnace slag. It relates more particularly to an improved steam condensation system design for use in such an installation.

### BACKGROUND ART

An example of a modern granulation installation of this type, especially for molten blast furnace slag, is illustrated in appended FIG. 2 that is part of a paper entitled “INBA® Slag granulation system—Environmental process control” published in Iron&Steel Technology, issue April 2005. As seen in FIG. 2, this kind of installation typically comprises: a water injection device [2] (also called blowing box), for injecting granulation water into a flow of molten material, e.g. slag that is received via a runner tip [1]. Thereby, granulation of the molten material is achieved. The installation further has a granulation tank [3] for collecting the granulation water and the granulated material and for cooling down the granules in a large water volume beneath the water injection device [2]. A steam condensation tower, typically having a cylindrical shell closed by a top cover, is located above the granulation tank for collecting and condensing steam generated in the granulation tank. In fact, due to the high temperatures of the molten material and the huge amount of quenching water required, a considerable amount of steam is typically produced by installations according to FIG. 2. To avoid pollution by simple emission of steam into the atmosphere, the steam condensation tower includes a steam condensing system, typically of the counter-current type. The steam condensing system has a water-spraying device [5] for spraying water droplets into steam that rises inside the steam condensation tower and a water-collecting device [6] located below the water injection device [5], for collecting sprayed condensing droplets and condensed steam.

Production of molten material in metallurgical processes is typically cyclic and subject to considerable fluctuations in terms of produced flow rates. For instance, during a tapping operation of a blast furnace, the slag flow rate is far from being constant. It shows peak values that may be more than four times the slag flow rate averaged over the duration of the tapping operation. Such peaks occur, occasionally or regularly, during short times, e.g. several minutes. It follows that, in a typical state of the art water-based granulation installation, there are important fluctuations in the incoming heat flow rate due to the incoming slag, accordingly, equivalent fluctuations in the amount of steam generated over time. In order to find a suitable compromise between installation size and costs, the steam condensation capacity is often not designed to handle the full steam flow, which might be generated during peak slag flows. Overpressure relief flaps are foreseen (as seen in the top cover shown in FIG. 2) to open in such cases, in order to evacuate excessive steam to the atmosphere. These overpressure relief flaps are also opened for evacuating hydrogen and in case of sudden deflagration.

However, observation has shown that, in practice, such overpressure flaps do not always reliably open at excess melt flow rates. It is theorized that steam is partially blocked from leaving through the overpressure flaps because, among others, of the “barrier” formed by the “curtain” of water constantly produced by the water injection device [2]. Possibly, at high steam rates, there is also resistance to steam flow formed by the water-collecting device [6]. Accordingly, excess steam remains inside the tower, and overpressure is subsequently generated. This can lead to partial backflow of steam at the lower inlet of the condensation tower, at the entrance of the granulation tank [3]. An internal hood is especially foreseen to separate the inside from the outside, and thus avoiding unwanted air to enter the tower and also preventing steam from being blown out of the tower.

Such reverse steam flow may lead, at the very least, to bad visibility in the casthouse, which is obviously a serious safety risk for operating personnel. Much more adversely, steam blowing back through the internal hood can lead to considerable generation of low-density slag particles (so-called “popcorn”) when the steam comes into contact with the liquid hot melt inside the slag runner spout. Such hot particles, when projected into the casthouse, generate an even more severe safety risk.

WO2012/079797 A1 addresses this problem as well and proposes to selectively evacuate the excess steam via a stack to the atmosphere. This stack has an inlet communicating with the lower zone of the condensation tower and an outlet arranged to evacuate steam to the atmosphere above the condensation tower. Furthermore, the stack is equipped with an obturator device for selective evacuation of steam through the stack.

WO2015/000809 A1 also addresses this problem, but by directly condensing the steam evacuated from a steam collecting hood within a dedicated evacuation device and releasing the remaining gas to the atmosphere. In preferred embodiments, the evacuation device comprises a vacuum pump, such as an eductor-jet pump that produces vacuum by means of the Venturi effect.

Under some circumstances, it has been noted that the amount of air in the condensation tower is considerably more important than usually expected. As a consequence, the temperature inside the condensation tower is indeed significantly lower than what is usually expected. Instead of having a temperature close to 100° C. due to the presence of “pure steam”, the temperature may be very close to ambient temperature due to the presence of less steam and a lot of false air. A significant amount of false air is thus seen as obstructive for the good functioning of the condensation tower.

### Technical Problem

Accordingly, it is a first object of the present invention to provide a steam condensation system, which enables more reliable evacuation of excessive steam during granulation at peak flow rates, while being compatible with existing granulation plant designs at comparatively low additional cost. This object is achieved by a granulation installation and a steam condensation system as claimed in claim 1.

It is another object of the invention to provide a steam condensation system that enables reduction in installation and operating costs of the plant.

### General Description of the Invention

The present invention generally relates to a granulation installation and to a steam condensation system as set out in the pre-characterizing portion of claim 1.

In order to overcome the above-mentioned problem, the present invention proposes a steam condensation system comprising a steam collecting hood located above the granulation tank, for collecting steam generated in the granulation tank, a gas conduit arranged between the steam collecting hood and a water column, and a gas compressor arranged within the gas conduit for compressing the steam before feeding it into (through) the water column.

The present invention thus proposes to use a steam collecting hood to collect the steam and air and any other components arranged therein, such as hydrogen or sulphur. The condensation tower is replaced by a gas compressor arranged within a gas conduit feeding the compressed steam and gas mixture to a water column.

The gas compressor sucks the steam and air from the steam collecting hood, raises the pressure of the gas mix and injects it into the water column of an already existing water reservoir such as e.g. the water recovery tank of a dewatering unit (often referred to as “hot water tank”) or the water recovery tank of a cooling tower (often referred to as “cold water tank”). Although the use of already existing water reservoirs is of course preferred for cost, space and maintenance reasons, the provision of a new dedicated water reservoir may also be envisaged and is encompassed herewith.

The pressure created by the gas compressor may be adapted and should be sufficient to overcome the pressure of the water column in these tanks such that the gas mix rises as bubbles inside these water volumes. This movement creates a significant surface for efficient condensation and sulphur dissolution. The condensation does thus no longer take place in a separate condensation tower but it is switched to an already existing water tank, thus resulting in lower investment costs and potentially better results due to an increased surface for efficient condensation. A water column in the context of the invention thus has its common meaning and is to be understood as a body or volume of water with a height sufficient to provide for an appropriate residence time of the gas mix bubbles within the water column. An appropriate height of the water column is therefore generally comprised between a few decimeters and a few meters. Appropriate gas pressures for injecting the steam and gas to the bottom of such water columns usually ranges between 0.05 and 2.0 bar(g), preferably between 0.1 and 1.0 bar(g). The volume of water within said water columns is easily determined by the skilled person depending among others on the quantity of heat to be extracted from the steam, the temperature differential, the quantities of components to be dissolved, etc.

The above-mentioned lower temperature of the gaseous mixture makes it possible to inject the gas into the bottom of the water recovery tank of the dewatering unit. Given that the temperature of the water in the water recovery tank is usually elevated and the temperature of the gaseous mixture is close to ambient, a significant temperature difference between these two substances is guaranteed. This temperature difference and the low concentration of vapor and sulphur in the gaseous mixture facilitates the dissolution and condensation of inside the water volume. Any sulfurous compounds contained in the steam will be dissolved and neutralized in the water. Calculation showed that about 385 l of water are needed to dissolve H₂S contained in one 1 t steam and about 142 l are needed to dissolve the complete SO₂ contained in one 1 t steam.

Furthermore, with the injection of the vapor and the gaseous sulphur in the water recovery tank of the dewatering unit, the gaseous mixture is in contact with solidified blast furnace slag, thus enabling a reaction between the gaseous sulphur and the solid slag to form gypsum through ionic recombination with Ca²⁺.

Although the above mainly discusses the injection of the gas mixture into the hot water tank, the injection of the gas mixture into the cold water tank is also envisaged, either as an alternative or as an addition.

In a further refinement of this invention, deviation plates may be arranged in the water column, in the area where the gaseous mixture is injected, in order to deviate the gases and thus create a longer residence time inside the liquid surroundings.

Also, the gas conduit may be connected to a distribution tube with perforations arranged within the water column. Such perforations are preferably arranged so as to distribute the steam into the water column at different locations, thereby obtaining an improved repartition of the steam in the water column.

A further steam collecting hood may be associated with the dewatering unit. A further gas compressor may be used to feed steam and gas mixture collected from the dewatering unit into the stream of gas mixture collected from above the granulation tank.

The gas compressor above the granulation tank has a volume flow of at least 20.000 Nm³/h, preferably at least 40.000 Nm³/h. The further gas compressor of the dewatering unit may have a lower volume flow of 5.000 to 10.000 Nm³/h.

It has been found that during the granulation of slag, hydrogen gas may under some circumstances be formed. Indeed, the hot liquid slag may contain iron and, in contact with the hot iron contained in the slag, water molecules may be split up into hydrogen and oxygen. This hydrogen gas is extremely explosive and since the condensation tower is basically air tight, the hydrogen gas, which is much lighter than air, may accumulate in the upper zone of the condensation tower. Under specific circumstances, this mixture may ignite and an explosion or a fire may be the consequence. Calculations have shown that during a granulation run, the hydrogen production may vary between about 0.5 m³ H₂/min and 8 m³ H₂/min, depending on the iron content of the slag and the diameter of the granules produced. Prior art solutions have suggested using overpressure relief flaps for evacuating hydrogen.

The installation of the present invention allows removing the hydrogen from the area above the granulation tank and transport it to a location further away from the hot melt flow, thus reducing the risk of fire or explosion.

The proposed steam evacuation system has the incontestable merit of safely evacuating any undesired and potentially harmful excess of steam and hydrogen from the granulation plant and thereby considerably increasing operation safety. Moreover, the proposed system allows to condensate the evacuated steam and to dissolve and neutralize the sulfur containing compounds in water, thus reducing the environmental effect of the plant. The use of already existing water reservoirs for carrying out the condensation process obviously leads to cost reduction.

The present invention also relates to a method for condensing steam generated in a granulation installation, the method comprising collecting steam generated in the granulation tank via the steam collecting hood; compressing the steam within the gas conduit; and feeding the steam into the water column and condensing the steam therein.

Preferred embodiments of the installation are defined in dependent claims. As will be understood, while not being limited thereto, the proposed installation is especially suitable for a blast furnace plant.

### BRIEF DESCRIPTION OF THE DRAWINGS

Further details and advantages of the present invention will be apparent from the following detailed description of a not limiting embodiment with reference to the attached drawings, wherein:

FIG. 1 is a block schematic diagram of an embodiment of a granulation installation equipped with a steam condensation system according to the invention;

FIG. 2 illustrates a known granulation installation according to prior art.

### DESCRIPTION OF PREFERRED EMBODIMENTS

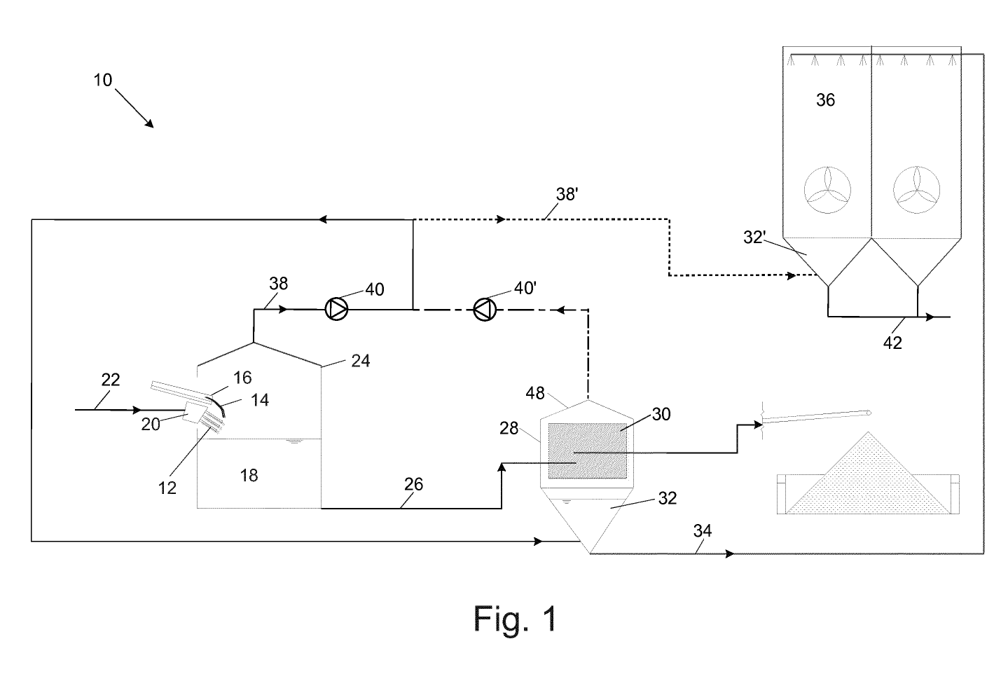

For illustrating an embodiment of the present invention, FIG. 1 shows a diagrammatic view of a granulation installation 10 designed for slag granulation in a blast furnace plant (the plant not being shown). Generally speaking, the installation 10 thus serves to granulate a flow of molten blast furnace slag 14 by quenching it with one or more jets 12 of comparatively cold granulation water. As seen in FIG. 1, a flow of molten slag 14, inevitably tapped with the pig iron from a blast furnace, falls from a hot melt runner tip 16 into a granulation tank 18. During operation, jets of granulation water 12, which are produced by a water injection device 20 (often also called a “blowing box”) supplied by a supply conduit 22, preferably comprising one or more parallel high-pressure pump(s) (not shown), impinge onto the molten slag 14 falling from the hot runner tip 16. A suitable configuration of a water injection device 20 is e.g. described in patent application WO 2004/048617. In older granulation installations (not shown, but encompassed), molten slag falls from a hot runner onto a cold runner, with jets of granulation water from a similar water injection device entraining the flow on the cold runner towards a granulation tank. Irrespective of the design, granulation is achieved when the granulation water jets 12 impinge on the flow of molten slag 14.

By virtue of quenching, the molten slag 14 breaks up into grain-sized “granules”, which fall into a large water volume maintained in the granulation tank 18. These slag “granules” completely solidify into slag sand by heat exchange with water. It may be noted that the jets of granulation water 12 are directed towards the water surface in the granulation tank 18, thereby promoting turbulence that accelerates cooling of the slag.

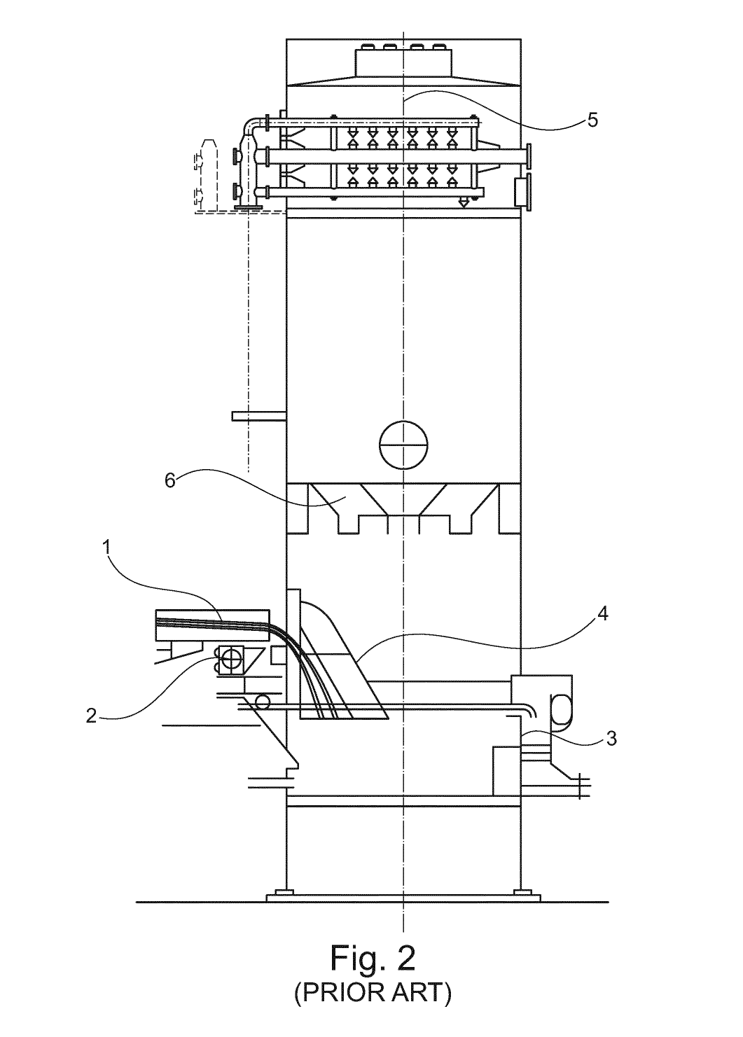

As is well known, quenching of an initially hot melt (>1000° C.) such as molten slag results in important quantities of steam (i.e. water vapor). This steam is usually contaminated, among others, with gaseous sulfur compounds. In order to reduce atmospheric pollution, steam released in the granulation tank 18 is collected in a steam collection hood 24 (hereinafter in short “hood 24”) that is located vertically above the granulation tank 18. As seen in FIG. 1, the hood 24 is a small edifice compared to a traditional condensation tower as shown in FIG. 2. The hood 24 has an external shell, which is typically but not necessarily a welded steel plate construction. The hood 24 has a certain height and diameter dimensioned for a volume of emitted steam/min. The hood 24 does not contain any water-spraying devices to condensate the steam as in a conventional condensation tower. During operation, steam rises from the granulation tank 18 into the hood 24.

As seen in FIG. 1, at the bottom of the granulation tank 18, solidified slag sand mixed with granulation water is evacuated via a drainage conduit 26. The mixture (slurry) is fed to a dewatering unit 28. The purpose of this dewatering unit 28 is to separate granulated material (i.e. slag sand) from water, i.e. to enable separate recovery of slag sand and process water. A suitable general configuration of a dewatering unit 28 is well known from existing INBA® installations or described e.g. in US Pat. No. 4,204,855 and thus not further detailed here. Such a dewatering unit comprises a rotary filtering drum 30, e.g. as described in more detail in US Pat. No. 5,248,420. Any other static or dynamic device for dewatering fine solidified melt granules may also be used. As further shown in FIG. 1, a granulation water recovery tank 32 (often called a “hot water tank”) is associated with the dewatering unit 28 for collecting water that is separated from the granulated slag sand. In most cases, this water recovery tank 32 is conceived as a settling tank with a settling compartment and a clean water compartment (not shown), into which the largely sand-free (“clean”) water overflows. The water from the water recovery tank 32 is feed through conduit 34 to a cooling system 36 that has one or more cooling towers.

Cooled process water from the cooling system 36 may be evacuated via an evacuation conduit 42 for disposal or for use elsewhere. Preferably, the evacuation conduit 42 is connected to the supply conduit 22 of the water injection device 20 via a recirculation conduit (not shown), thus forming a “closed-circuit” configuration for process water.

According to an important aspect of the present invention, the hood 24 is connected to a gas conduit 38 comprising an evacuation device 40 for extracting steam and gas from the hood 24. The evacuation device 40, as schematically illustrated in FIG. 1, is preferably a gas compressor compressing the steam and gas collected from the hood 24 and feeding the compressed gas down the gas conduit 38.

The gas conduit 38 is connected to a lower portion of the water recovery tank 32 of the dewatering unit 28 at a pressure superior to the pressure reigning in the water recovery tank 32. Upon entering the water recovery tank 32, the compressed steam and gas expands and bubbles up through the water in the water recovery tank 32 while interacting therewith.

According to the present invention, condensation of the steam is not carried out in a large condensation tower. Instead, condensation of the steam is effected in a water column, preferably in a water column that is already present in the granulation installation 10 anyway. The water recovery tank 32 of the dewatering unit 28 is a good candidate for providing the water column needed for condensation of the steam. The pressure created by the gas compressor should be sufficient to overcome the pressure of the water column and said gas mix should then rise as bubbles inside the water volume. For the water recovery tank 32 (below dewatering drum), the normal working pressure usually ranges from 0.05 to 1.0 bar(g), preferably from 0.1 to 0.5 bar(g). This movement creates a significant surface for efficient condensation and sulphur dissolution. The condensation does thus no longer take place in a separate condensation tower but it is switched to an already existing water tank, thus resulting in lower investment costs and potentially better results due to an increased surface for efficient condensation.

Deviation plates (not shown) may be arranged in the lower part of the water recovery tank 32 in the area where the gaseous mixture is injected in order to deviate the gases and thus create a longer residence time inside the liquid surroundings.

A distribution tube (not shown) connected to the gas conduit may be arranged within the water column. Such a distribution tube may comprise a number of perforations arranged so as to distribute the steam into the water column at different locations. This may further improve the repartition of the steam in the water column.

A further gas compressor 40′ may be used to extract steam and gas from the dewatering unit 28 via a further steam collection hood 48 above the rotary filtering drum 30. The gas compressor 40′ may be installed so as to suck off steam and gas from the dewatering unit 28 and/or from the steam collection hood 48. This configuration has the benefit of properly evacuating steam and gas from the dewatering unit 28 and condensing the steam and thus reducing visibility problems in the surroundings of the dewatering unit 28 and the installation 10 in general.

Alternatively or additionally, the granulation installation may comprise a cooling system 36, in particular a cooling tower 36, having a water recovery tank 32′ with a water column. The compressed gas from either or both of the compressors 40, 40′ can be fed to the bottom of the water column in said water recovery tank 32′ via gas conduits 38, 38′. For the water recovery tank 32′ (below cooling tower), the normal working pressure range usually is from 0.05 to 2.0 bar(g), preferably between 0.1 and 1.0 bar(g).

Preferably, the gas compressor(s) 40, 40′ is (are) connected to a controller, which can be integrated into the process control system of the entire plant. The gas compressors are preferably controlled by frequency converters and an adjustable flow rate valve for keeping the same pressure at differing flow rates. The flow rate adjustment may be based on a pressure measurement inside the steam collecting hood, in particular the steam collecting hood 24.

In conclusion, it will be appreciated that the present invention not only enables an important increase in operational safety of a water-based granulation installation 10, especially for blast furnace slag. In addition, the invention permits reliable operation at lower capital and operating expenditure.

### LEGEND

10 granulation installation 30 rotary filtering drum
12 water jets 32 water recovery tank (of 28)
14 melt flow 32′ water recovery tank (of 36)
16 hot runner tip 34 conduit
18 granulation tank 36 cooling system (cooling tower)
20 water injection device 38, 38′ gas conduit
22 supply conduit (of 20) 40 gas compressor
24 steam collecting hood 40′ further gas compressor
26 drainage conduit 42 evacuation conduit
28 dewatering unit 48 further steam collecting hood

1. A granulation installation for granulating molten material produced in a metallurgical plant, said installation comprising:
a water injection device, for injecting granulation water into a flow of molten material and thereby granulating the molten material;
a granulation tank for collecting the granulation water and the granulated material;
characterized by a steam condensation system comprising:
a steam collecting hood located above said granulation tank, for collecting steam generated in said granulation tank,
a water column configured to dissolve and condensate gas therein,
a gas conduit arranged between said steam collecting hood and said water column,
a gas compressor arranged within said gas conduit for compressing said steam from the steam collecting hood before feeding it through said water column.

2. The granulation installation as claimed in claim 1, further comprising a dewatering unit, in particular a dewatering unit with a rotary filtering drum, having a water recovery tank, characterized in that said water column to which said gas conduit is connected is said water recovery tank of said dewatering unit.

3. The granulation installation as claimed in claim 1, further comprising a cooling system, in particular a cooling tower, having a water recovery tank, characterized in that said water column to which said gas conduit is connected via branch is said water recovery tank of said cooling system.

4. The granulation installation as claimed in claim 1, characterized in that said water column to which said gas conduit 484 is connected is a dedicated water reservoir.

5. The granulation installation as claimed in claim 1, further comprising deviation plates arranged in said water column, so as to deviate incoming steam for longer residence time within the water column.

6. The granulation installation as claimed in claim 1, wherein said gas conduit is connected to a distribution tube arranged within said water column, said distribution tube comprising a number of perforations for distributing said steam into said water column at different locations.

7. The granulation installation as claimed in claim 2, further comprising
a further steam collecting hood located above said dewatering unit, for collecting steam generated in said dewatering unit,
a further gas compressor arranged within a gas conduit connecting to said gas conduit.

8. The granulation installation as claimed in claim 1, wherein said gas compressor is connected to a controller for controlling said gas compressor.

9. The granulation installation as claimed in claim 1, wherein said gas compressor has a volume flow of at least 20.000 Nm³/h, preferably at least 40.000 Nm³/h.

10. The granulation installation as claimed in claim 1, wherein said further gas compressor has a volume flow of between 5.000 Nm³/h and 10.000 Nm³/h.

11. A method for condensing steam generated in a granulation installation, said granulation installation comprising a steam condensation system with a steam collecting hood located above a granulation tank and a gas conduit comprising a gas compressor connected between said steam collecting hood and a water column;
wherein said method comprises:
collecting steam generated in said granulation tank via said steam collecting hood;
compressing said steam within said gas conduit; and
feeding said steam into said water column, dissolving and condensing said steam within said water column.

12. The method according to claim 11, wherein said steam is fed to a water recovery tank of a dewatering unit and/or to a water recovery tank of a cooling system and/or to a dedicated water reservoir.

13. The method according to claim 11, comprising the further steps of:
collecting steam generated in a dewatering unit via a further steam collecting hood;
compressing said steam within said gas conduit by means of a further gas compressor; and
feeding said steam into said water column and condensing said steam within said water column.

14. A blast furnace plant comprising a granulation installation as claimed in claim 1.
